(19) United States
(12) Patent Application Publication
(10) Pub. No.: US 2002/0080820 A1
(43) Pub. Date: Jun. 27, 2002

(54) Shared transmission of control information in high data rate communications systems

(76) Inventors: Bassam M. Hashem, Nepean (CA); Yoon Chae Cheong, Kanata (CA); Shalini S. Periyalwar, Ottawa (CA)

Correspondence Address: Gowling Lafluer Henderson LLP, Suite 2600, 160 Elgin Street, Ottawa, ON, K1P 1C3, CA

(21) Appl. No.: 09/741,349

(22) Filed: Dec. 21, 2000

(51) Int. Cl. H04J 3/16; H04J 3/22; H04J 3/12

(52) U.S. Cl. 370/471; 370/522

(57) ABSTRACT

A method for sharing transmission of control messages over high data rate networks. Whenever there are data transmitted on the downlink, the control messages are piggybacked. If there is no data transmitted on the downlink, a shared control MAC frame is used. The variable size shared control MAC frame includes same type of control messages for a plurality of fixed terminals. Control information identifiers (CIIDs) are used to indicate the type of the transmitted control messages. The appropriate control information is timely delivered to an identified terminal. Such scalable MAC frame allows for flexibility and an efficient use of high data rate (HDR) transmissions.

### BACKGROUND OF THE INVENTION

1. Field of invention

This invention is generally concerned with transmission of control information over communications systems, and in particular with shared transmissions of control information in high data rate communications systems.

2. Related art

Cellular Systems have been typically designed for voice services and have been enhanced to support data transmission as well. These systems have a tendency to be more circuit oriented due to the continuous nature of voice calls.

The control information is sent over the forward connection (downlink transmission) from the base station to the terminal for controlling the reverse connection (uplink transmission) from the terminal to the base station. The downlink transmission is point-to-multipoint and the uplink transmission is point-to-point. For reliable connection communications, the control information must be timely delivered.

Circuit switched (analog) communications systems have dedicated control channels. A control channel is generally assigned to one user for controlling the connection and this represents an unnecessary waste of bandwidth.

In packet oriented communications systems (digital systems) the control information is usually short and can be piggybacked with the transmitted data. Thus, transmission of control information for terminals is not an issue whenever a continuous transmission of data exists.

In packet oriented networks, an entire frame may be used to distribute control information, since terminals may require transmission of control messages at different times. This is also a waste of resources and can increase the likelihood of interference with other terminals.

FIG. 1 illustrates, by way of example, a variable length media access control (MAC) frame 10 with a standard header 15 and a payload 17. The header 15 includes a field 11 indicating the type of frame. In this example, “1” indicates a control frame. A field 12 indicates the type of the control message, which is power control (PC) in this example. Field 13 contains the encryption bit (EN). A 16 bit field 16 is used to select users and services based on a connection identification (CID). Field 21 contains the fragmentation number, while field 23 contains the fragmentation sequence. Field 22 contains reserved bits. Various fields 14 may be reserved. A 10 bit field 18 indicates the length of the payload 17. The length of the payload 17 can not be arbitrary small as there is a specified minimum channel bandwidth to be allocated.

Packet oriented systems are supporting variable transmission rates. This makes the size of the used channel variable. The used channel may be based on time slot, frequency band, or orthogonal frequency division multiplexing (OFDM) subcarriers. As mentioned before, the channel size is limited to a specified minimum channel allocation, or a dedicated minimum frame size, since a too small size frame may result in a more complex data scheduler.

For example HDR standard uses a time slot of 1.67 msec which can carry 334 kbit at a transmission rate of 2 Mbps. In OFDM systems, a reasonable minimum dedicated transmission size is ⅛ of a symbol, which means 128 subcarriers in a system using 1024 subcarriers. Assuming 64 quadrature amplitude modulation (QAM), this results in 768 bits to be transmitted. Relaying on piggybacking only to transmit few bits of control messages with the transmitted data, necessitates 1,67 msec in HDR, and ⅛ of a symbol in OFDM. This reduces the system throughput if there is no data to be transmitted.

Piggybacking control information with regular data transmission requires data to be actually transmitted to the user. Still, in packet oriented networks, it is quite possible that there is no data transmitted to the terminal, but the uplink transmission still needs to be controlled.

Various types of downlink control messages are available like for example power control, time alignment, acknowledgments, or combinations thereof. These very short messages are the foundation for a reliable connection.

As mentioned before, a dedicated channel to carry such control messages is a waste of resources. Piggybacking is usually employed to carry control messages but this is not always possible in packet oriented networks where there is no continuous downlink transmission.

Accordingly, there is a need for timely transmissions of control messages in packet oriented networks in situations where there is no continuous downlink transmission.

### SUMMARY OF THE INVENTION

The present invention seeks to overcome the disadvantages of the prior art associated with timely transmission of control information in communications systems where there is no continuous downlink transmission.

In accordance with a preferred aspect of the invention, a shared control MAC frame for transmitting control messages to a plurality of fixed terminals in a wireless communications system, each terminal having a connection identification (CID), is provided. Firstly, it is determined when to broadcast a type of control messages. If data is currently transmitted on the downlink frame and there is space available in the frame, the control messages are piggybacked with said transmitted data. If data is not currently transmitted on the downlink frame, a media access control (MAC) information is transmitted to said fixed terminals. The MAC information comprises a MAC control frame structure for distributing a control message to each terminal. The MAC control frame structure includes a plurality of activity fields containing control messages, one activity field for each terminal. The activity field includes a first field containing the CID and a second field containing control information, as well as a control information identifier (CIID) field specifying the type of control messages included in the frame. It is understood that other fields may be added if necessary.

Advantageously, the invention provides a mechanism for timely transmitting control information to all terminals even in situations when there is no continuous transmission of data on the downlink. As well, control messages are automatically transmitted to terminals whenever there is space available in the downlink frames for enhancing the quality of the transmission on the uplink channel.

The “Summary of the Invention” does not necessarily disclose all the inventive features. The invention may reside in a sub-combination of the disclosed features.

### BRIEF DESCRIPTION OF THE DRAWINGS

The invention will be now explained by way of example only and with reference to the following drawings.

FIG. 1 illustrates a variable length MAC frame;

FIG. 2 illustrates a standard MAC frame for data transmissions;

FIG. 3 illustrates a shared control MAC frame according to the invention; and

FIG. 4 is a flow chart illustrating the method of sharing transmission of control messages according to the invention.

Similar references are used in different figures to denote similar components.

### DETAILED DESCRIPTION OF THE PREFERRED EMBODIMENTS

The following description is of a preferred embodiment by way of example only and without limitation to combination of features necessary for carrying the invention into effect.

When a terminal is connected to a base station the downlink transmissions carry data to a specific terminal as well as control messages related to the uplink transmissions. Examples of the control information are power control, time alignment and acknowledgments. These are usually very short messages.

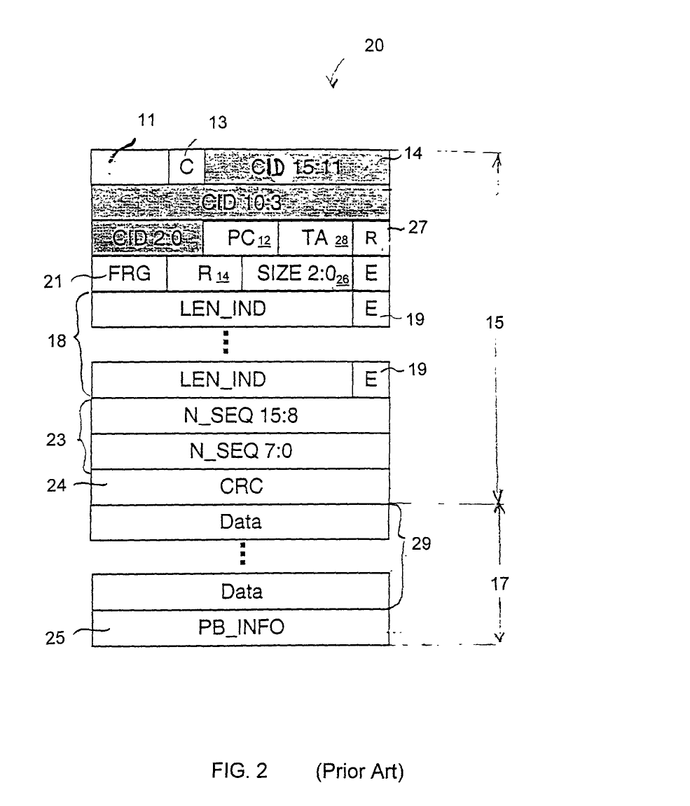

FIG. 2 illustrates a standard MAC frame 20 for data transmissions. The payload 17 contains both the data 29 transmitted to the terminal, and a control message 25 required for the reverse link transmission. An extension bit (E), field 19, indicates whether or not there is a control message transmitted with the data. If for example E=1, the terminal looks into the payload for a control message in field 25. The LEN_IND field 18 indicates the length of the control message.

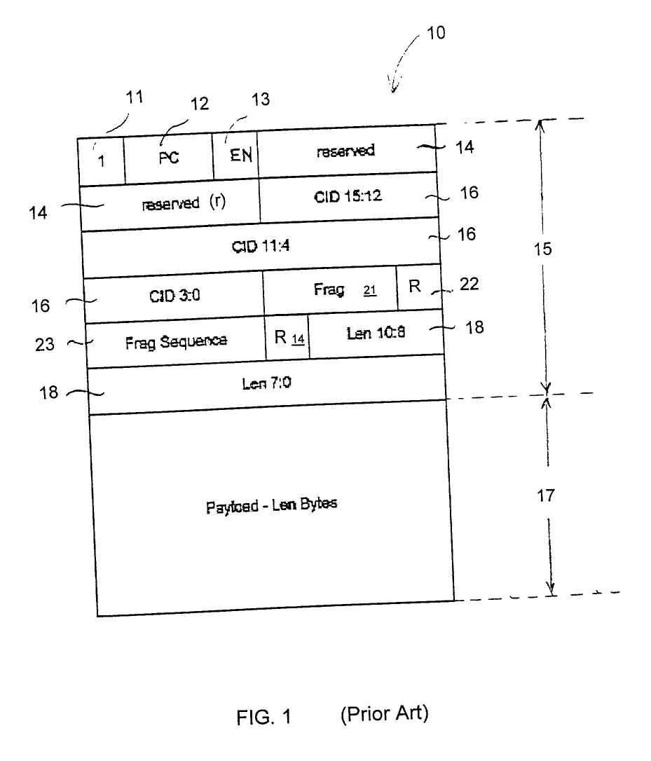

Field 26 indicates the size of the data field 29. Field 24 contains the cyclic redundancy check (CRC) bits. Field 27 contains reserved bits and field 28 indicated the type of the control messages, or time alignment (TA) in this example. The other fields have been described in connection with FIG. 1.

For fixed wireless systems, it is assumed that the fixed terminal is always active, either communicating or in stand by, for receiving all the transmitted frames and selecting its own data. In such systems, it is expected that a large number of users are actively communicating with one sector of the base station, and an even larger number of users are in standby, but still in need of receiving control messages at a slower rate. It is a huge burden for the system to transmit control messages to such a large number of users if it has to use separate control frames for each user, especially when the transmission should be based on high-speed techniques.

Packet oriented systems have to support variable transmission rates. As a consequence, the transmission frame (time slot, frequency band, OFDM Symbols) has a variable size and there is a specified limit on the minimum frame size, as mentioned before. Assuming the system is OFDM, a minimum dedicated transmission of ⅛ of a symbol requires 4 bits in each OFDM symbol to indicate the beginning of a new frame. Even such a small granularity (⅛ of a symbol) is too large to send short control messages. This is more evident in the case when high order modulation is used, e.g. 64 QAM and 256 QAM.

The control messages are normally piggybacked with data transmission if there is dedicated data going to the terminal on the downlink. However, as the data transmissions are bursty in nature, a continuous transmission can not be assumed. The data packets arrive to the base station un-deterministically and therefore, in situations when there is no dedicated data going to a terminal on the downlink, a dedicated MAC frame is currently used to carry only control information (Cl) for a single terminal. In high data rate systems, such a frame may be too large for the short control messages delivered, which results in a waste of bandwidth.

The present invention proposes a shared control MAC frame. This type of frame appears to be suitable for high data rates (HDR) transmissions as the control messages are short and more terminals can be timely controlled. The size of the MAC frame is specified to a minimum granularity, or minimum dedicated transmission size due to physical constraints, and this makes the use of a shared control MAC frame even more effective.

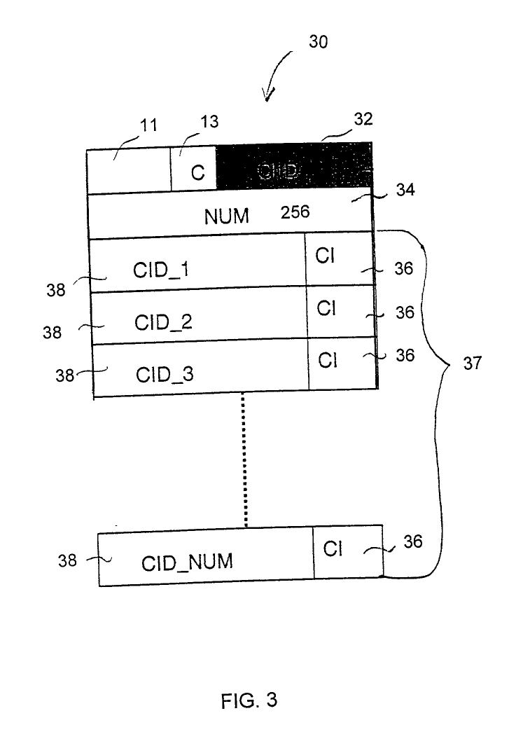

FIG. 3 illustrates a shared control MAC frame 30 according to one embodiment of the invention. As illustrated in FIG. 3, a new field 32 for indicating the type of control information contained in the shared control MAC frame 30 such as single control type, e.g. power control only, or a combination control type, e.g. power control and time alignment combined. For example, <A000> may indicate power control (PC), and <A001> may indicate time alignment.

Each control message includes a first field 38 containing the connection identification (CID) number, or users/services information, and a second field 36 containing the control information (CI) for the respective connection.

Field 34 indicates the number of control messages included in payload 37. Field 37 is so designed to specify all the terminals, as frame 30 is of a variable size and can be customized for each network.

Due to the specified minimum granularity, there may be space available in payload 37 which may be automatically filled with control messages to increase the downlink throughput and improve the uplink transmission quality (more control information is provided).

The shared control MAC frame 30 can be further simplified by using explicit signalling between transmissions of frames 30 to indicate in advance which control information (CI) field 36 is assigned to the respective terminal. The CID number field 38 is therefore not included in payload 37 such that more control information (CI) fields 36 may be included in frame 30. By transmitting more control information in a timely manner and more frequently, the control function is significantly improved.

The invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and the actions can be performed by a programmable processor executing a program of instructions by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least on output device. Each program can be implemented in a high-level procedural or object oriented programming language, or in assembly or machine language if desired; and in any case, the language can be a compiled or interpreted language.

Suitable processors include, by way of example, both general and special purpose microprocessors. Generally, such a processor receives instructions and data from a read-only memory and/or a random access memory.

The system according to the invention includes one or more mass storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the forgoing can be supplemented by, or incorporated in, ASICs (application-specific integrated circuits).

A data scheduler may be used to determine the urgency for sending control messages based on life time, frequency change, or signal strength parameters as it is well known in the art.

A hybrid approach may be used for exchange of control information on the downlink. Namely, whenever there are data transmitted on the downlink, the control messages are piggybacked. If there is no data transmitted on the downlink, a shared control MAC frame 30 can be used. Frame 30 can carry same type of control messages for different terminals. The type of control messages included in frame 30 is specified in the connection identifier (CIID), field 32. All terminals receive the shared MAC frame 30 and check the connection identification(CID) in field 38 to determine the recipient of the control information. The appropriate control information is thus timely delivered to an identified terminal, while the rest is discarded. Such scalable MAC frame 30 allows for flexibility and an efficient use of high data rate transmissions.

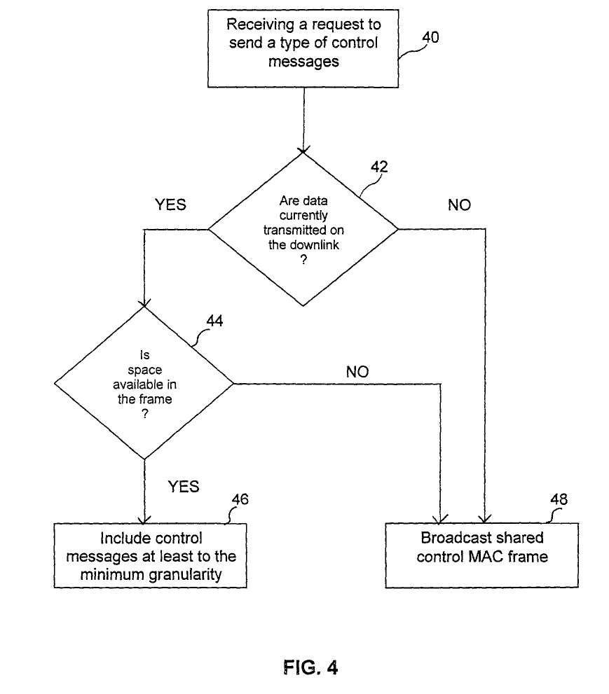

FIG. 4 is a flow chart illustrating the shared transmission of control information according to the invention. A request to send a type of control information is received at step 40. At step 42 it is determined whether or not there are data transmitted on the downlink. If data are transmitted and there is space available in the downlink frames, step 44, control information are piggybacked with the data and are added in the frame so as to satisfy the minimum granularity requirement, step 46. If there are no data transmitted on the downlink, or there is no space in the downlink frames, a shared control MAC frame containing one type of control messages is broadcasted to the terminals, step 48.

Numerous modifications, variations, and adaptations may be made to the particular embodiments of the invention without departing from the scope of the invention which is defined in the claims.

1. A method for transmitting a type of control messages to a plurality of fixed terminals of a wireless communications systems, each said fixed terminals having a connection identification (CID), said method comprising the steps of:
a) determining when to broadcast said type of control messages;
b) if data is currently transmitted on the downlink, piggybacking said control messages with said transmitted data; and
c) if data is not currently transmitted on the downlink, transmitting a media access control (MAC) information to said fixed terminals, said MAC information comprising a control message for each said fixed terminals.

2. The method of claim 1, wherein said MAC information comprising a MAC control frame structure for distributing said control message to each said fixed terminals, said MAC control frame structure comprising:
one activity field for each said fixed terminals, said activity field including a first field containing said CID and a second field containing control information,
a control information identifier (CIID) field specifying said type of control messages, and
a number field indicating the number of said control messages contained in said MAC control frame structure.

3. The method of claim 2, further comprising the step of accessing said control information based on said CID.

4. The method of claim 1, wherein said type of control messages including power control, time alignment, acknowledgements, and combinations thereof.

5. The method of claim 1, wherein said control messages are automatically included in a downlink frame whenever the size of said downlink frame is smaller than a minimum granularity.

6. The method of claim 2, further comprising the step of signalling in advance to a designated terminal a location in said MAC frame containing said control information for said designated terminal.

7. A computer-readable medium containing computer executable instructions for transmitting a type of control messages to a plurality of fixed terminals in a wireless communications systems, each said fixed terminals having a connection identification (CID), said medium for performing the steps of:
a) determining when to broadcast said type of control messages;
b) if data is currently transmitted on the downlink, piggybacking said control messages with said transmitted data; and
c) if data is not currently transmitted on the downlink, transmitting a media access control (MAC) information to said plurality of fixed terminals, said MAC information comprising a control message for each said fixed terminals.

8. The computer-readable medium of claim 7, wherein said MAC information comprising a MAC control frame structure for distributing said control message to each said fixed terminals, said MAC control frame structure comprising:
one activity field for each said fixed terminals, said activity field including a first field containing said CID and a second field containing control information,
a control information identifier (CIID) field specifying said type of control messages, and
a number field indicating the number of said control messages contained in said MAC control frame structure.

9. The computer-readable medium of claim 8, further comprising the step of accessing said control information based on said CID.

10. The computer-readable medium of claim 7, wherein said type of control messages including power control, time alignment, acknowledgements, and combinations thereof.

11. The computer-readable medium of claim 7, wherein said control messages are automatically included in a downlink frame whenever the size of said downlink frame is smaller than a minimum granularity.

12. The computer-readable medium of claim 8, further performing the step of signalling in advance to a designated terminal a location in said MAC frame containing said control information for said designated terminal
